(19) United States
(12) Patent Application Publication
(10) Pub. No.: US 2006/0098295 A1
(43) Pub. Date: May 11, 2006

(54) Method for forming optical elements

(76) Inventor: Hajime Yamanaka, Saitama (JP)

Correspondence Address: YOUNG & THOMPSON, 745 SOUTH 23RD STREET, 2ND FLOOR, ARLINGTON, VA, 22202, US

(21) Appl. No.: 11/261,670

(22) Filed: Oct. 31, 2005

(30) Foreign Application Priority Data
Nov. 8, 2004 (JP) 2004-324058

(51) Int. Cl. G02B 27/14

(52) U.S. Cl. 359/631

(57) ABSTRACT

A method for forming an optical element having a rotationally asymmetric optically functional surface from an optical block comprises the steps of putting a polygonal optical block chamfered at respective corners in a cavity formed between upper and lower moulds, advancing the upper and lower moulds to each other so as to bring a rotationally asymmetric transfer surface of the mold into contact with a center of the block, and pressing the block between the upper and lower moulds from the center toward a periphery of the block so as thereby to transfer the rotationally asymmetric transfer surface to the block.

### BACKGROUND OF THE INVENTION

1. Field of the invention

The present invention relates to a method for forming optical elements such as an optical lens and an optical mirror.

2. Description of Related Art

Conventionally, press molding is one of well known methods for forming optical elements such as mirrors. The method for press molding of an optical element includes heating a preform for the optical element put in position in a metal mould and coupling and clamping upper and lower moulds together. This type of forming method encounters the problem that it is difficult to recreate a precise curved transfer surface when an optical element has a rotationally asymmetric curved surface as an optically functional surface. Unexamined Japanese Patent Publication No. 2001-278629 discloses a method for press molding of an optical element such as a projector mirror having a rotationally asymmetric curved surface as an optically functional surface. In the prior art method for forming a projector mirror having a rotationally asymmetric curved surface in press molding, the transfer of curved surface is performed by bringing a center of a preformed optical blank and a center of a mould surface into contact with each other first and then pressing the mould surface against all-around surface of the preformed optical blank

Reference is made to FIGS. 8 and 9 for the purpose of providing a brief background that will enhance an understanding of the method of the present invention. According to the prior art method, when a preformed optical blank 100 for an optical mirror has a rectangular flat surface, an upper mould is depressed down toward a lower mould so as to bring a core transfer surface of a core of the upper mould into contact with the optical block from the center to the periphery. Because the rectangular surface of the optical block 100 has a distance a from the center x to any corner (vertical edge) longer than a distance b from the center x to any side (horizontal edge) thereof, the optical block 100 has surface transfer adaptability at area near the respective corners inferior to the remaining areas. Further, as shown in FIG. 9, the preformed optical blank 100 for an optical mirror has a rotationally asymmetric optically functional surface 101 which possibly causes local deformations such as flex cracking and dulled edges (turned down edges), having an adverse effect on an optical performance of the optically functional surface 101, at the corners after forming. It is considered the probable cause of aggravation of transfer characteristic at the corners that the optical block is subject to differences in temperature distribution among various local areas, differences in internal stress among various local areas due to compression by a mould core and/or differences in surface sink among various local areas due to cooling all of which result from a difference in duration of the contact with the mould core between local areas at the distance a and local areas at distance b.

### SUMMARY OF THE INVENTION

It is therefore an object of the present invention to provide a method for forming an optical element having a rotationally asymmetric surface as an optically functional surface from a polygonal optical block in press molding in which a rotationally asymmetric mould surface is transferred to the optical block precisely and finely over the whole area from a center to the corners thereof.

The foregoing objects are achieved by a method for forming an optical element from an optical block with the use of upper and lower moulds at least one of which has a rotationally asymmetric transfer surface to be transferred to the optical block in press molding. The optical element forming method comprises the steps of preparing a polygonal optical block chamfered at respective corners in a direction in which an upper mould and a lower mould are pressed against each other for press molding; putting the polygonal optical block in a cavity formed between the upper and lower moulds; causing the upper and lower moulds to get close to each other so as to bring the rotationally asymmetric mould surface into contact with a center of the optical block, and pressing the optical block between the upper and lower moulds from the center toward a periphery of the optical block so as thereby to transfer the rotationally asymmetric mould surface as an optically functional surface to the optical block in press molding. The chamfer at the corner has a size preferably in a range of from 0.5 to 2.5 mm as viewed in a direction passing through a center of a plane including a surface of the polygonal optical block. The polygonal optical block may be preformed.

The use of a polygonal optical block chamfered at corners achieves uniform temperature distribution, besides uniform internal stress distribution, during molding and in addition, causes only small differences in surface sink among locations during cooling, resulting in satisfactory surface transfer performance. Although it has not been unusual in conventional press molding to yield a defective fraction beyond 30%, the optical element forming method of the present invention yields a defective fraction less than 5%.

### BRIEF DESCRIPTION OF THE DRAWINGS

The foregoing and other objects and features of the present invention will be clearly understood from the following detailed description when reading with reference to the accompanying drawings, wherein the same reference signs have been used to denote same or similar parts throughout the drawings, and in which:

FIG. 1 is a plan view of a lower mould with an optical block put therein;

FIG. 2 is a perspective view of an optical block used in the optical element forming method;

FIG. 3 is a cross-sectional view of a mould in an early stage of press molding;

FIG. 4 is a cross-sectional view of the mould in a clamped stage of press molding;

FIG. 5 is a plan view of a molded product as an optical element;

FIG. 6 is a side view of the molded product;

FIG. 7 is an explanatory view showing a chamfer width;

FIG. 8 is a plan view of an optical block used in conventional press molding; and

FIG. 9 is a plan view of a molded product as an optical element formed in conventional press molding.

### DETAILED DESCRIPTION OF THE PREFERRED EMBODIMENTS

In the following description, the term “rotationally asymmetric surface” as used hereinafter shall mean and refer to a surface that is asymmetric when rotated about an axis line (a normal line) of the surface passing through the surface center x. That is, while any shapes other than a circular surface having its center as a rotational center can be said to be rotationally asymmetric, blocks in which the present invention is effectively embodied are made in polygonal forms such as rectangles or squares.

Referring to the accompanying drawings in detail, and in particular, to FIGS. 1 to 4 schematically showing a method forming an optical element in press molding according to an embodiment of the present invention, a generally rectangular optical block 1 after heating is put in a press mould comprises stationary upper metallic mould 10 and movable lower metallic mould 20 installed in a clamping machine (not shown) and then press formed in a desired shape.

The upper mould 10 comprises a face mould 12 attached to a fixed table of a clamping machine (not shown) and a press die or core 11 movably mounted in the face mould 12. The core 11 has a core transfer surface 11A to be transferred to the optical block 1. In this instance, the core transfer surface 11A is shaped convex and rotationally asymmetric. The lower mould 20 comprises a face mould 22 attached to a movable table of the clamping machine and an intermediate mould form 21 fixed to the face mould 22 by set screws. The intermediate mould form 21 provides a regular rectangular cavity 21A between the upper and lower moulds 10 and 20 in which the optical block 1 that is preferably preformed and heated is put The upper and lower moulds 10 and 20 are coupled and clamped so that the convex core 11 at its apex is brought into contact with a center x of the optical block 1 and then depressed against the optical block 1 in such a way that the convex core 11 compress the optical block 1 from the center x to the periphery so as thereby to transfer a profile of the rotationally asymmetric core transfer surface 11A to the optical block 1 while forming an optical element 2 shown by a chain double-dashed line in FIG. 1. The optical element 2 is formed in a plano-concave shape having a rotationally asymmetric concave surface 3 complementarily mating with the core transfer surface 11A of the core 11 that is convex.

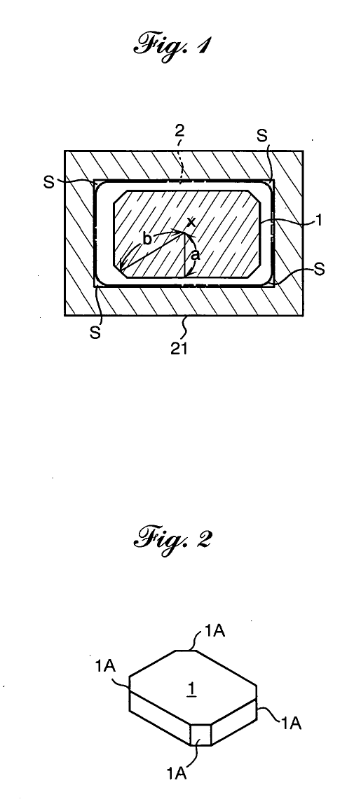

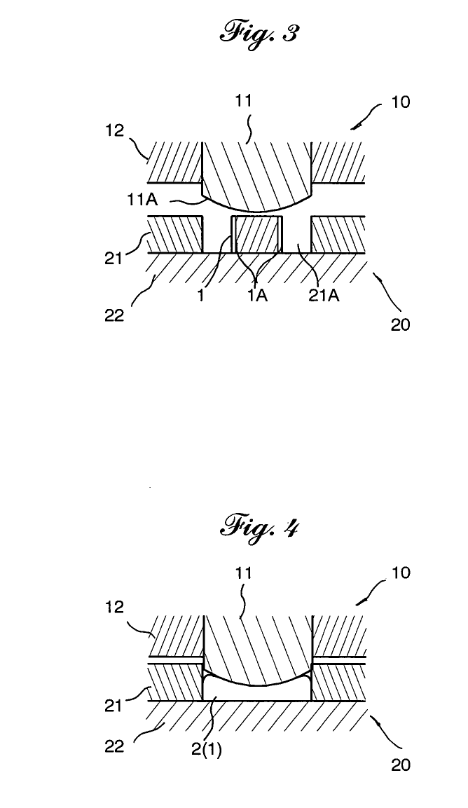

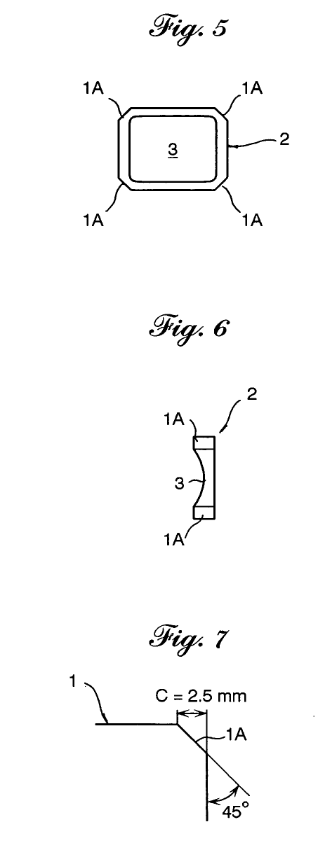

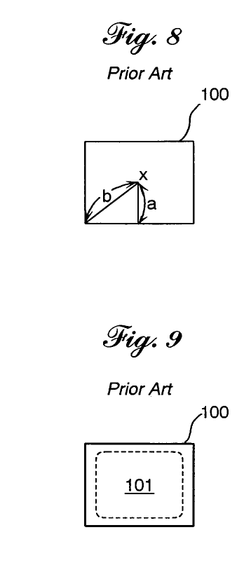

As shown in FIG. 2, the optical block 1 is preferably prepared in a generally rectangular shape with four chamfered corners 1A and has a half breadth a′, i.e. a distance from a center x to a side and a half diagonal distance b ′, i.e. a distance from the center x to the chamfered corner 1A. This half diagonal distance b′ is shorter than a half diagonal distance b of the regular rectangular optical block 100 shown in FIG. 9 similar in shape to the optical block 1. As was previously described, the optical block 1 with four chamfered corners 1A after heating is put in the regular rectangular cavity 21A provided by the intermediate mould form 21 on the lower mould 20 as shown in FIG. 3 and then pressed by the convex core 11 as shown in FIG. 4 so as thereby to be formed as a plano-concave optical element 2 having a rotationally asymmetric surface 3 as an optically functional surface at its front shown in FIGS. 5 and 6. The moulded optical element 2 made from the optical block 1 with four chamfered corners 1A always leaves clearances S at four corners in the regular rectangular cavity 21A as shown in FIG. 1 and, however, may leave or may not leave clearances at four sides in the regular rectangular cavity 21A.

According to a practical demonstration of molding an optical mirror from a 45×35.5×8 mm (length×breadth×thickness) preformed optical block with a chamfer of 2.5 mm in a diagonal direction at each corner in the mould heated at a tool temperature of approximately 580° C. under a mould clamping force of 300 kg for 5 minutes, the optical block did not bring on perceivable aggravation of surface transfer adaptability in the vicinity of the chamfered corners 1A. Further, the optically functional surface 3 even having a shortened half diagonal distance was formed certainly without any trouble.

Referring to FIG. 7 showing an example of the chamfer 1A, a chamfer is formed by cutting off the corner partially at 45 degrees with respect to the edge line of the relevant corner so as to have a chamfered width C of 2.5 mm in a diagonal direction (a direction along a line passing through the center x and the corner of a surface of the polygonal optical block).

The chamfer 1A may be formed all the way along the corner as shown in FIG. 2 or only partially as shown in FIG. 7. In any case, it is preferred for the optical block 1 to have a chamfered width C in a diagonal direction (a direction along a line passing through the center x and the corner of a surface of the polygonal optical block) in a range of from 0.5 to 5.0 mm and further may have not flat chamfers but curved chamfers at the respective corners.

As just described above, according to the present invention, during heating the optical block having a half diagonal distance b′ shortened as compared with that of conventional optical blocks and pressing it gradually from the center toward the periphery, temperature distribution and internal stress in the optical block are uniformized, besides the optical block causes only small differences in surface sink among locations during cooling. As a result, the accuracy of surface transfer is improved.

Although the above description has been directed to an embodiment in which an optical element having a rotationally asymmetric concave surface as an optically functional surface is formed with the use of a core having a convex transfer surface, it is a matter of course that an optical element having a rotationally asymmetric convex surface as an optically functional surface is formed with the use of a core having a concave transfer surface in the optical element forming method. Further, in the embodiment described above, the surface transfer is performed by the aid of the core 11 provided as a separate member from the face mould 12 of the upper mould 10, it is possible to adopt a general mould comprising upper, lower and blow moulds only.

It is to be understood that although the present invention has been described with regard to preferred embodiments thereof, various other embodiments and variants may occur to those skilled in the art which are within the scope and spirit of the invention, and such other embodiments and variants are intended to be covered by the following claims.

What is claimed is:

1. A method for forming an optical element having a rotationally asymmetric surface as an optically functional surface from an optical block with the use of upper and lower moulds at least one of which has a rotationally asymmetric transfer surface to be transferred as an optically functional surface to said optical block in press molding, said optical element forming method comprising the steps of:
preparing a polygonal optical block chamfered at respective corners in a direction in which said polygonal optical block is pressed between said upper and lower moulds;
putting said polygonal optical block in a cavity formed between said upper and lower moulds;
making said upper and lower moulds advance to each other so as to bring said rotationally asymmetric transfer surface into contact with a center of said polygonal optical block, and pressing said polygonal optical block between said upper and lower moulds from said center toward a periphery of said polygonal optical block so as thereby to transfer said asymmetric transfer surface to said polygonal optical block.

2. A method for forming an optical element as defined in claim 1, wherein a size of said chamfered corner is in a range of from 0.5 to 2.5 mm in a direction along a line passing through both said center and corner of a surface of the polygonal optical block.

3. A method for forming an optical element as defined in claim 1, wherein said polygonal optical block is preformed so as to have a surface similar to said rotationally asymmetric transfer surface.
